(19) United States
(12) Patent Application Publication
(10) Pub. No.: US 2024/0148591 A1
(43) Pub. Date: May 9, 2024

(54) ORTHOPEDIC GRAVITY BACK STRETCHER

(71) Applicant: Christopher Bass, Northport, NY (US)

(72) Inventor: Christopher Bass, Northport, NY (US)

(21) Appl. No.: 18/505,245

(22) Filed: Nov. 9, 2023

Related U.S. Application Data
(60) Provisional application No. 63/423,870, filed on Nov. 9, 2022.

(51) Int. Cl. A61H 1/02

(52) U.S. Cl. CPC A61H 1/0229; A61H 1/0292; A61H 2203/0487

(57) ABSTRACT

An orthopedic back stretcher includes a back portion, a first side portion hingedly connected to the back portion and having a first support surface, and a second side portion hingedly connected to the back portion and having a second support surface. An orthopedic back stretcher kit and methods of using the orthopedic back stretcher and/or orthopedic back stretcher kit are also provided.

### CROSS-REFERENCE TO RELATED APPLICATIONS

This application claims priority to and the benefit of U.S. Provisional Application No. 63/423,870, having a filing date of Nov. 9, 2022, the entire contents of which are hereby incorporated by reference.

### FIELD OF THE INVENTION

The subject matter disclosed herein relates generally to spine stretching and aligning devices. More particularly, the subject matter relates to a structure for conveniently stretching and/or aligning the spine using gravity safely and without additional force. The structure may be foldable, transportable, and lightweight while having necessary rigidity and stability. Related kits and related methods are also disclosed.

### BACKGROUND OF THE INVENTION

Many people suffer from discomfort, pain, lack of mobility, injury, wear, etc. due to spinal alignment issues. These issues can arise from strenuous activities, sports, age, posture, accidents, injuries, etc. Relatedly, many people rely on chiropractic treatment, physical therapy, and the like to treat back problems and alignment issues. These treatment options are often expensive, time consuming, and/or require multiple treatments. Further, the treatment options are often painful and/or debilitating and may result in additional time out of work.

Consumer realignment devices and pain relief programs for at home use are known in the conventional art; however, such devices and programs have shown limited to no success. Further, many of these devices and programs are associated with safety concerns. For example, some devices involve inverting the user—these devices can result in excess blood flow to and blood pressure in the head, particularly to the small capillaries in the head and brain. Further, these so-called inversion tables can result in increased blood pressure, headaches, blurred vision, dizziness, fainting, etc. Other devices involve tension on the cervical spine, for example, neck slings that attach to a door or other support and stretch the vertebrae and discs of the neck. While all portions of the spine are important, the cervical spine is crucial, delicate, and complicated. Unsupervised stretching of the cervical spine presents a risk for major injury and is not recommended.

Improved consumer devices, kits, and methods for back stretching, realignment, and pain relief, would be well received in the art.

### BRIEF DESCRIPTION OF THE INVENTION

According to one aspect, an orthopedic back stretcher comprises a back portion, a first side portion hingedly connected to the back portion and having a first support surface, and a second side portion hingedly connected to the back portion and having a second support surface.

According to another aspect, an orthopedic back stretcher kit comprises a back portion, a first side portion configured to hingedly connect to the back portion and having a first support surface, and a second side portion configured to hingedly connect to the back portion and having a second support surface.

According to another aspect, a method of stretching a user's back comprises providing a back portion, a first side portion hingedly connected to the back portion and having a first support surface, and a second side portion hingedly connected to the back portion and having a second support surface, wherein the back portion, the first side portion, and the second side portion define a user area when in an unfolded configuration in which the first side portion and second side portion are unfolded away from the back portion, and positioning the user in the user area such that the user's body is located inside the user area and the user's arms are located outside the user area.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a front view of an orthopedic back stretcher in accordance with an embodiment of the invention;

FIG. 2 depicts a back view of the orthopedic back stretcher of FIG. 1 in accordance with an embodiment of the invention;

FIG. 3 depicts a side view of the orthopedic back stretcher of FIGS. 1-2 in accordance with an embodiment of the invention;

FIG. 4 depicts a side perspective view of the orthopedic back stretcher of FIGS. 1-3 in a folded configuration accordance with an embodiment of the invention;

FIG. 5 depicts a side perspective view of the orthopedic back stretcher of FIGS. 1-4 in use in accordance with an embodiment of the invention;

FIG. 6 depicts a side perspective view of an orthopedic back stretcher in accordance with a further embodiment of the invention; and

FIG. 7 depicts a side perspective view of an orthopedic back stretcher in accordance with a still further embodiment of the invention, wherein the orthopedic back stretcher is in use.

### DETAILED DESCRIPTION OF THE INVENTION

A detailed description of the hereinafter described embodiments of the disclosed apparatus and method are presented herein by way of exemplification and not limitation with reference to the Figures.

In brief overview, an orthopedic gravity back stretcher that is easy to use, easy to configure and set up, and easy to transport is disclosed. The orthopedic gravity back stretcher is stable and secure.

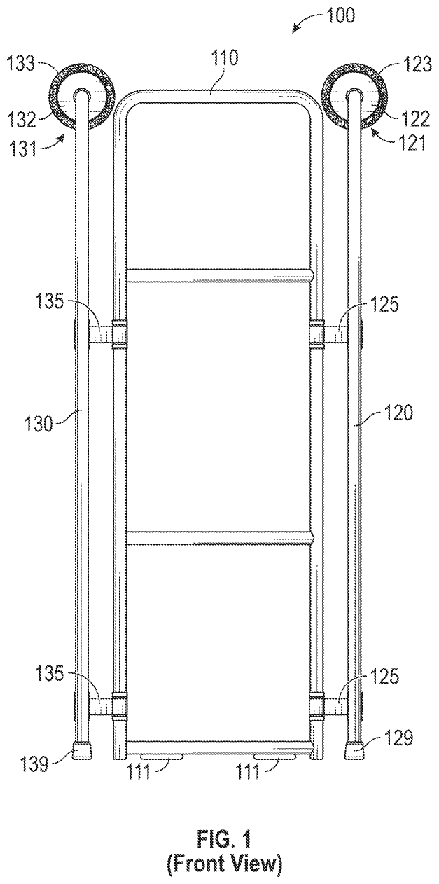

Referring firstly to FIG. 1, a front view of an orthopedic back stretcher 100 according to embodiments is shown. The orthopedic back stretcher 100 comprises a back portion 110. The back portion 110 may be formed of wood, metal, plastic, a composite, or any other sufficiently durable material. In embodiments, steel or aluminum may be chosen. As depicted, the back portion 110 is formed by pipes or tubes—use of such material may reduce weight while retaining durability. For clarity, the terms pipe and/or tube encompasses both a hollow material as well as a non-hollow material such as a bar. In the embodiment shown, vertically extending pipes/tubes are connected by horizontally extending pipes/tubes and/or the material of the back portion 110 is bent or otherwise shaped into vertically extending portions connected by horizontally extending portions. However, in further embodiments, the back portion 110 may also be a solid material or may be substantially solid with cut outs. The back portion 110 may also include at least one support base 111. In the embodiments of FIG. 1, two support bases 111 are shown.

The orthopedic back stretcher 100 also comprises a first side portion 120 and a second side portion 130. Like the back portion 110, the first side portion 120 and/or the second side portion 130 may be formed of wood, metal, plastic, a composite, or any other sufficiently durable material. In embodiments, steel or aluminum may be chosen. As depicted, the first side portion 120 and the second side portion 130 are formed by pipes or tubes or bars as discussed in more detail with respect to the back portion 110. However, the first side portion 120 and the second side portion 130 may also be a solid material or may be substantially solid with cut outs.

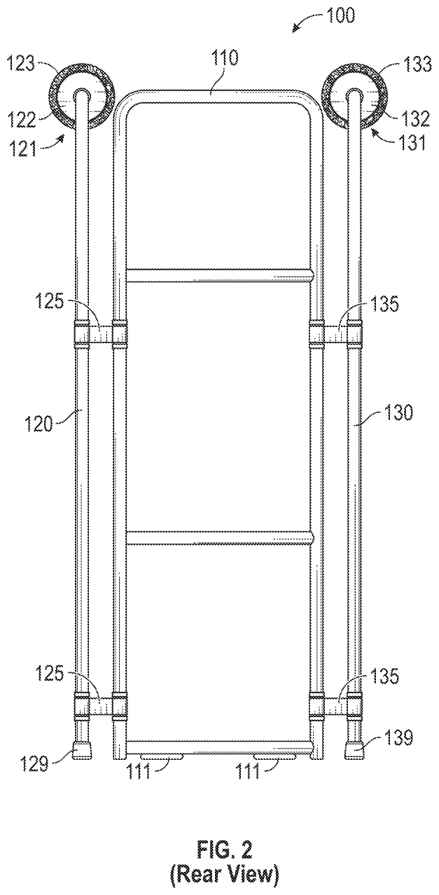

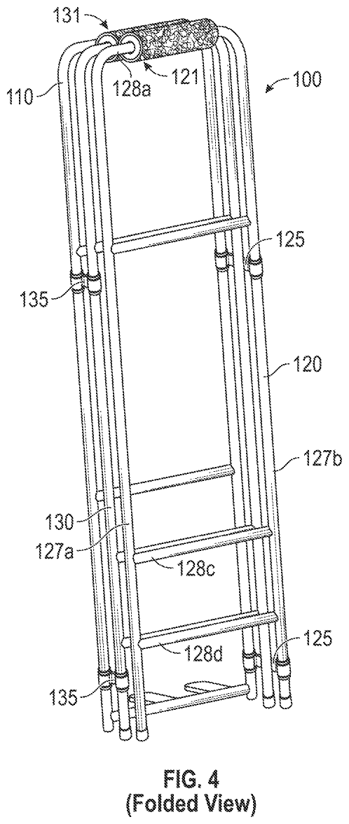

The first side portion 120 and/or the second side portion 130 may be hingedly connected to the back portion 130. For example, as shown a first hinge 125 may connect the first side portion 120 to the back portion 110 and a second hinge 135 may connect the second side portion 130 to the back portion 110. In the embodiments shown, two sets of first hinges 125 and two sets of second hinges 135 are used. It will be understood that various numbers of hinges could be used. Likewise, different types of hinges may be used. In embodiments the first hinge 125 and/or the second hinge 135 may comprise a side sleeve portion for surrounding the pipe/tube of the respective side portion as well as a back sleeve portion for surrounding the pipe/tube of the back portion 110. The side sleeve portion may be connected to the back sleeve portion by a connecting portion. The first hinge and/or the second hinge may be constructed using the same material as the back portion 110, the first side portion 120, and/or the second side portion 130 in embodiments. Alternatively or additionally, other materials may be used. The hinged connection between the respective side portions and the back portions may enable the orthopedic back stretcher 100 to change between an unfolded configuration (as shown in FIG. 1 as well as in FIGS. 2, 3, and 5) and a folded configuration (as shown in FIG. 4).

Referring still to FIG. 1, the first side portion 120 may comprise a first support surface 121 and/or the second side portion 130 may comprise a second support surface 131. In embodiments, the first support surface 121 may comprise, or may be covered by, cushioning material. As an example, a dual layer material such as a dual layer foam may be used. Likewise, the second support surface 131 may comprise, or may be covered by, cushioning material. Again, as an example, a dual layer material such as a dual layer foam may be used. As depicted in the embodiments shown in FIGS. 1-5, the first support surface 121 may comprise, or may be covered by dual layer material having a first inner layer 122 and a first outer layer 123. Likewise, the second support surface 131 may comprise, or may be covered by dual layer material having a second inner layer 132 and a second outer layer 133. In embodiments, the first inner layer 122 and/or the second inner layer 132 may be a dense, rigid, or hard material or foam, for example, material or foam intended to provide support and cushioning. In embodiments, the first outer layer 123 and the second outer layer 133 may be a foam or material of the same type or of a different type. For example, the first outer layer 123 and the second outer layer 133 may be a hypoallergenic material or foam, a material or foam that provides better user feel, a material or foam that is softer and more cushioning, and/or a material or foam that is more sanitary.

Referring to FIG. 2, a rear view of the orthopedic back stretcher 100 according to embodiments is shown. This view more clearly shows the hinged connection between the back portion 110 and the first side portion 120 as well as the hinged connection between the back portion 110 and the second side portion 130. Further, the first set of hinges 125 and the second set of hinges 135 are more clearly visible from this view.

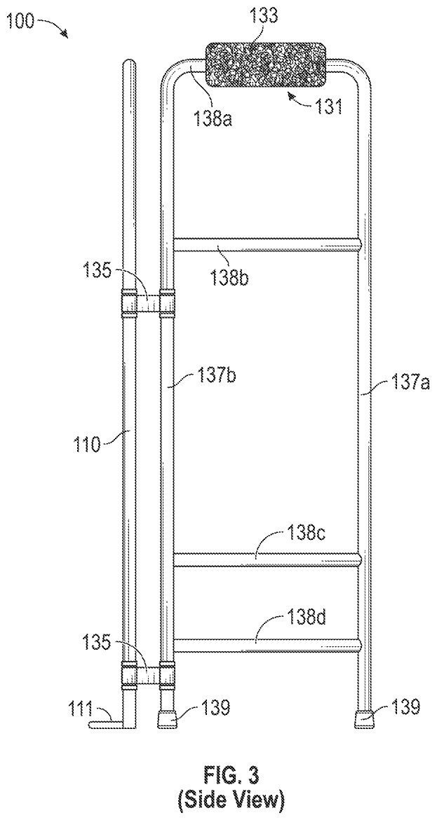

Referring now to FIG. 3, a side view of the orthopedic back stretcher 100 according to embodiments is shown. This view more clearly shows a respective side portion, in this case the second side portion 130, as well as a respective support surface, in this case the second support surface 131. Further, the second outer layer 133 is more clearly visible from this view. Also depicted in more detail is the at least one support base 111 of the back portion 110. As depicted clearly in this Figure, in embodiments, the at least one support base 111 extends from the back portion 110, for example, away from a direction of the first side portion 120 and the second side portion 130.

With reference still to the side view of FIG. 3, in embodiments the second side portion 130 may be formed of pipes or tubes or bars as discussed above. Other material may also be used. Again, as discussed above, the second side portion may be formed of connected vertical portions and horizontal portions. The vertical and horizontal portions may be integrally formed or may be attached to each other. For example, in embodiments such as that depicted, two vertical portions 137a, and 137b may be connected by four horizontal portions 138a, 138b, 138c, and 138d. In different embodiments, a different number of horizontal portions may be used and/or a different number of vertical portions may be used.

Further, in embodiments, the second support surface 131 may be formed by a horizontal portion. For example, as depicted, the second support surface 131 is formed by the horizontal portion 138a. Alternatively, the second support surface 131 could be formed by the horizontal portion 138b. Still further, it is also contemplated that multiple second support surfaces 131 may be included, for example on both horizontal portion 138a and 138b, either at the same time or as selectable configurations. For example, two or more of the horizontal portions may be second support surfaces and may both include or be covered by cushioning material or cushioning material may be moveable between two or more of the horizontal portions.

In some embodiments, one or more of the horizontal portions 138a, 138b, 138c, and 138d may be configured to be used as a step or support. For example, in the depicted embodiments horizontal portion 138c and/or 138d may be used as a step. The respective horizontal portion may comprise or be covered by a nonslip surface, for example, rubber or similar material.

As shown, the second side portion 130 may comprise one or more second side bottom supports 139. The one or more second side bottom supports 139 may be features designed ensure proper contact is made with a floor or other surface, and may include, for example, anti-slip features, grip features, and the like.

It will be understood that the embodiments discussed herein with respect to the second side portion 130 shown in FIG. 3 may apply equally to the first side portion 120. For example, the first side portion may also include vertical portions such as two vertical portions 127a, and 127b, horizontal portions such as horizontal portions 128a, 128b, 128c, and 128d, and/or one or first side more bottom supports 129. For convenience, these features of the first side portion 120 are shown in FIG. 4. In embodiments, the first side portion 120 and the second side portion 130 are substantially similar and/or identical, such that they are mirror images of each other. However, this level of similarity is not required, and the respective side portions may independently comprise any of the embodiments or features discussed herein.

Referring more specifically to FIG. 4, a side perspective view of the orthopedic back stretcher 100 according to embodiments is shown—in this figure the orthopedic back stretcher 100 is depicted in a folded configuration. In the folded configuration, the first side portion 120 and the second side portion 130 may be folded inward toward each other and toward the back portion 110. In contrast, the embodiments depicted in FIGS. 1-3 may be referred to as an unfolded configuration wherein the first side portion 120 and the second side portion 130 are unfolded away from each other and away from the back portion 110. As can be seen in FIG. 4, the folded configuration may take up a smaller volume of space, for example, for storage, transport, and the like.

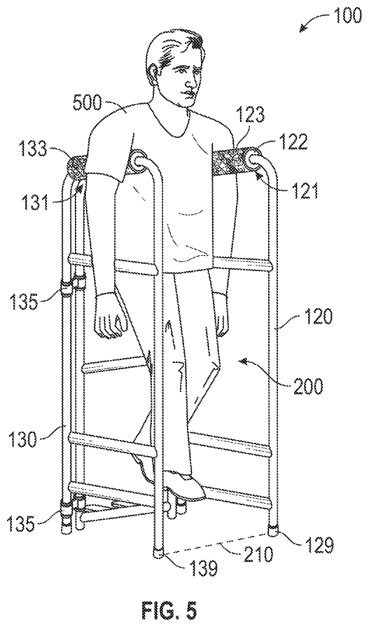

FIG. 5 depicts a side perspective view of the orthopedic back stretcher 100 in use by a user 500 according to embodiments. As shown, the back portion 110, first side portion 120, and second side portion 130 generally define a user area 200. The user area 200 is a space or volume generally located inside an imaginary box created by the back portion 110, the first side portion 120, the second side portion 130, and an imaginary front edge of the orthopedic back stretcher 100, the imaginary front edge represented by dashed line 210 as shown in FIG. 5. For the purposes of the description, the user area 200 may be considered to extend continuously upward, even above the horizontal portions 138a, 138b, 138c, and 138d of the respective side portions.

Use of the orthopedic back stretcher 100 will now be described with reference to the user 500. As shown, the user 500 may be positioned within the user area 200 such that the user's body is located in the user area 200 with the exception of the user's arms. Instead, the user's arms may be located outside the user area 200 such that the user's shoulder/underarm contacts the first support surface 121 and/or the second support surface 131. For example, as shown in the depicted embodiment, the user's shoulder/underarm contacts the cushioning material on the first support surface 121 and on the second support surface 131. Still further, in the depicted embodiment, the first support surface 121 and the second support surface 131 are located on the highest respective horizontal portions of the respective side portions, i.e., horizontal portion 138a. As discussed above, the respective support surfaces could instead be located on a different horizontal portion of the respective side portions, for example, horizontal portion 138b. Such a configuration may be used, for example, if the user 500 was shorter than depicted. Thus, the orthopedic back stretcher 100 may be adaptable to users of varying heights. Alternatively or additionally, the orthopedic back stretcher may be configured to be adjustable, i.e., a height, length, or width of the user area may be adjustable by adjusting a height, length, or width of the back portion 110, first side portion 120, and/or second side portion 130 and/or components thereof. For example, in some embodiments, the pipes/tubes of the respective portions may include extendible/adjustable features. For example, push button features, spring pins, locking pins, and other similar features allow for sliding adjustment of longitudinal elements may be used.

As can be understood from FIG. 5, the orthopedic back stretcher 100, particularly the first side portion 120 and the second side portion 130 can support a weight of the user 500. Further, the user 500 is supported at the shoulder/underarm area. Accordingly, the user 500, particularly the user's back/spine hangs freely below that area. For example, the user's thoracic spine, or portions thereof, as well as the lumbar spine, sacral spine, and coccyx, hang freely while the user 500 is in position on the orthopedic back stretcher 100. In this position, gravity is allowed to act on these portions of the spine, relieving pressure on the vertebrae and discs, and allowing natural body alignment without use of mechanical or manual force.

Further, as can be seen from FIG. 5, the orthopedic back stretcher 100 does not contact or directly engage the neck nor the cervical spine. Thus, this crucial and complex section of the spine is protected from the potential dangers discussed above.

Turning back to portions of the spine below the cervical spine, the operation of gravity may serve to relieve pressure, facilitate decompression, and the like. In many situations, the user 500 may only need to be in position on the orthopedic back stretcher 100 for a short amount of time, for example, minutes or even seconds, in order to feel the effects of gravity on the vertebrae and discs. In some embodiments, a period of 30 to 40 seconds may be sufficient to relieve pressure and provide decompression.

The orthopedic back stretcher 100 is secure and stable when the user 500 is in position. For example, the weight of the user inherently presses the back portion 110, the first side portion 120, and/or the second side portion 130 securely into the floor or other support surface. Still further, the one or more bottom supports 129 and/or 139 provide contact with the floor that will not slip nor slide. Moreover, the at least one support base 111 may extend opposite the user area 200, thus extending the contact with the floor and providing even greater support and stability, for example, by preventing tipping in a backward direction.

In some embodiments, lower horizontal portions of the respective side portions, for example, as discussed above horizontal portion 138c and/or 138d may provide a surface for the user 500 to use while getting into position on the orthopedic back stretcher 100 and dismounting from the orthopedic back stretcher 100. For example, horizontal portions 138c and/or 138d may be used as a step when the user 500 steps up to position the user's weight on the first support surface 121 and the second support surface 131 and also when the user 500 takes the user's weight off the first support surface 121 and the second support surface 131 and steps down. As discussed above, the respective horizontal portions(s) may comprise or be provided with a nonslip or anti-slip surface or material.

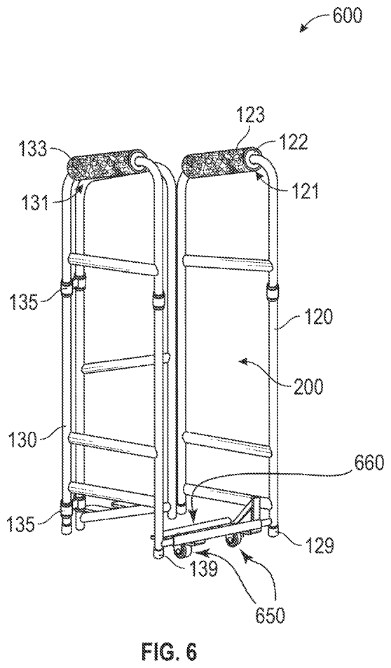

Referring now to FIG. 6, an orthopedic back stretcher 600 is shown according to a further embodiment. The embodiment shown in FIG. 6 includes many of the same features as the embodiments shown in FIGS. 1-5 as will be recognized by the similar reference numerals. However, the orthopedic back stretcher 600 differs in that the orthopedic back stretcher 600 is or comprises a weight actuated lock step rolling orthopedic back stretcher. For example, the orthopedic back stretcher 600 includes at least one wheel 650. In the depicted embodiment, two wheels 650 are shown. The two wheels 650 are placed between the side portions 120, 130 opposite the back portion 110. In some embodiments, an alternative number of wheels may be used or the wheels may be placed at other locations, for example, proximate the back portion. Further, in some embodiments, additional wheels may be placed proximate the back portion 110 and/or at other locations.

Further, the orthopedic back stretcher 600 may have a weight actuated lock step 660, such as that found on rolling ladders and similar devices. For example, if/when a user places the user's weight on the orthopedic back stretcher 600 the wheels 650 may be prevented from rolling. Instead, the wheels 650 may be locked by the weight actuated lock step 660. In some embodiments, the wheels 650 may be disengaged or otherwise made incapable of rolling. When the user's weight is removed, the wheels 650 may be unlocked, may be engaged, or may otherwise be made capable of rolling. Similar to the wheels 650, the weight actuated lock step 660 may be placed between the respective side portions 120, 130 opposite the back portion 110. In other embodiments, the weight actuated lock step 660 may be placed at a different location and/or additional weight actuated lock steps 660 may be provided in other locations.

In some embodiments, the orthopedic back stretcher 600 may not be adjustable, but may be intended to be a more stable device while still being capable of being moved using the wheels 650. However, it will be understood that in some embodiments the orthopedic back stretcher 600 may be adjustable similar to the orthopedic back stretcher 100 discussed above.

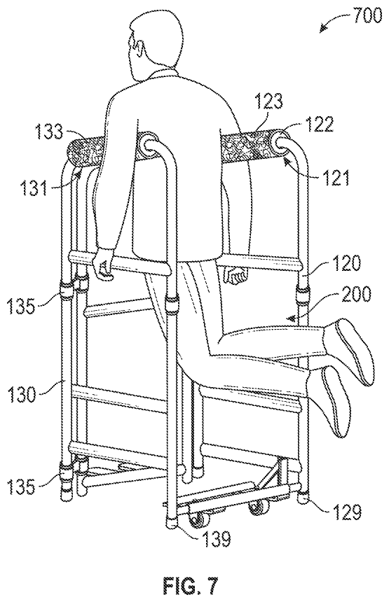

Referring now to FIG. 7, an orthopedic back stretcher 700 is shown according to a still further embodiment. The embodiment shown in FIG. 7 includes many of the same features as the embodiments shown in FIGS. 1-6 as will be recognized by the similar reference numerals. However, the orthopedic back stretcher 700 differs in that the orthopedic back stretcher 700 may have a shorter height than in other embodiments and may be configured to be used differently. For example, as shown in FIG. 7, a user 700 may enter the user area 200 facing the back portion 110. Further, instead of needing to step up (for example, using one or more of the horizontal portions such as 128c, 128d, 138c, 139d) the user 700 may be able to walk into the user area 200, and place the user's weight on the first support surface 121 and/or the second support surface 131 by positioning the user's arms/shoulder area proximate to the first support surface 121 and/or the second support surface 131 and lifting the user's legs behind the user 700 as shown.

The orthopedic back stretcher 700 may comprise wheels and/or a weight actuated lock step such as those discussed with respect to FIG. 6; however, these features are not required. Further, the orthopedic back stretcher 600 may or may not be adjustable as discussed above.

In some embodiments, an orthopedic back stretcher kit may be provided. The orthopedic back stretcher kit may include a back portion such as the back portion 110, a first side portion such as the first side portion 120, and a second side portion 130. The first side portion and the second side portion may each be configured to hingedly connect to the back portion, for example, using the first hinge 125 and the second hinge 135 discussed above. Further, the first side portion may have a first support surface such as the first support surface 121 discussed above and the second side portion may have a second support surface such as the second support surface 131 discussed above. The first support surface and/or the second support surface may include or may be configured to attach to cushioning material such as dual layer foam as discussed above. The first side portion and the second side portion of the orthopedic back stretcher kit may be configured to fold toward each other and toward the back portion to form a folded configuration as discussed above. Likewise, the first side portion and the second side portion of the orthopedic back stretcher kit may be configured to fold away from each other and away from the back portion to form an unfolded configuration as discussed above. In embodiments, the back portion of the orthopedic back stretcher kit may include at least one support base such as the at least one support base 111 discussed above. Likewise, the first side portion and/or the second side portion of the orthopedic back stretcher kit may include one or more bottom supports such as the one or more bottom supports 139 discussed above. Still further, the first side portion and/or the second side portion may be formed by at least two vertical supports and a horizontal support connecting the at least two vertical supports as discussed above. Likewise, the first side portion and/or the second side portion may include a horizontal support capable of directly supporting a user's weight as discussed above. In some embodiments, the orthopedic back stretcher kit may further comprise wheels, such as the wheels 650 discussed above, and/or may comprise a weight actuated lock step, such as the weight actuated lock step 660 discussed above.

It will be understood that embodiments and features described with respect to the orthopedic back stretcher 100, 600, and/or 700, and embodiments thereof, may also apply or be applied to the orthopedic back stretcher kit and embodiments thereof, and vice versa.

In embodiments, a method of stretching a user's back is provided. The method may comprise providing pain relief, providing realignment, providing decompression, and the like. In general, the method comprise providing a back portion such as back portion 110, providing a first side portion such as first side portion 120, wherein the first side portion is hingedly connected to the back portion and has a first support surface such as the first support surface 121, and providing a second side portion such as the second side portion 130, wherein the second side portion is hingedly connected to the back portion and has a second support surface, such as the second support surface 131. In embodiments, the back portion, the first side portion, and the second side portion define a user area such as user area 200 when in an unfolded configuration in which the first side portion and second side portion are unfolded away from the back portion. According to embodiments, the method further comprises, positioning the user in the user area such that the user's body is located inside the user area and the user's arms are located outside the user area. In still further embodiments, the method may include supporting a weight of the user on the first support surface and the second support surface.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

I claim:

1. An orthopedic back stretcher, comprising:
a back portion,
a first side portion hingedly connected to the back portion and having a first support surface, and
a second side portion hingedly connected to the back portion and having a second support surface.

2. The orthopedic back stretcher of claim 1, wherein the first side portion and second side portion can fold toward the back portion to form a folded configuration and can unfold away from the back portion to form an unfolded configuration.

3. The orthopedic back stretcher of claim 2, wherein the back portion, first side portion, and second side portion define a user area when in the unfolded configuration.

4. The orthopedic back stretcher of claim 1, wherein the back portion includes at least one support base.

5. The orthopedic back stretcher of claim 4, wherein the support base extends from the back portion opposite a user area.

6. The orthopedic back stretcher of claim 1, wherein the first support surface and/or the second support surface are formed from a dual-layer foam.

7. The orthopedic back stretcher of claim 1, wherein at least one of the first side portion and the second side portion are formed by at least two vertical supports and a horizontal support connecting the at least two vertical supports.

8. The orthopedic back stretcher of claim 1, wherein at least one of the first side portion and the second side portion include a horizontal support capable of directly supporting a user's weight.

9. The orthopedic back stretcher of claim 1, further comprising at least one wheel and a weight actuated lock step.

10. An orthopedic back stretcher kit, the kit comprising:
a back portion,
a first side portion configured to hingedly connect to the back portion and having a first support surface, and
a second side portion configured to hingedly connect to the back portion and having a second support surface.

11. The orthopedic back stretcher kit according to claim 10, wherein the first side portion and second side portion are configured to fold toward the back portion to form a folded configuration and unfold away from the back portion to form an unfolded configuration.

12. The orthopedic back stretcher kit according to claim 11, wherein the back portion, first side portion, and second side portion are configured to define a user area when in the unfolded configuration.

13. The orthopedic back stretcher kit according to claim 10, wherein the back portion includes at least one support base.

14. The orthopedic back stretcher kit according to claim 13, wherein the support base extends from the back portion opposite a user area.

15. The orthopedic back stretcher kit according to claim 10, wherein the first support surface and/or the second support surface include a dual-layer foam.

16. The orthopedic back stretcher kit according to claim 10, wherein at least one of the first side portion and the second side portion are formed by at least two vertical supports and a horizontal support connecting the at least two vertical supports.

17. The orthopedic back stretcher kit according to claim 10, wherein at least one of the first side portion and the second side portion include a horizontal support capable of directly supporting a user's weight.

18. The orthopedic back stretcher kit according to claim 10, further comprising at least one wheel and a weight actuated lock step.

19. A method of stretching a user's back, comprising:
providing a back portion, a first side portion hingedly connected to the back portion and having a first support surface, and a second side portion hingedly connected to the back portion and having a second support surface, wherein the back portion, the first side portion, and the second side portion define a user area when in an unfolded configuration in which the first side portion and second side portion are unfolded away from the back portion, and
positioning the user in the user area such that the user's body is located inside the user area and the user's arms are located outside the user area.

20. The method according to claim 19, wherein a weight of the user is supported on the first support surface and the second support surface.
